(19) United States
(12) Patent Application Publication
(10) Pub. No.: US 2006/0064581 A1
(43) Pub. Date: Mar. 23, 2006

(54) Email encryption method and system

(76) Inventors: Ronald W. Miller, East Brighton (AU); John R. Freeman, Little River (AU); David J. Wilson, Mulgrave (AU); David M. Oppenheim, Beaumaris (AU); Jeremy T. Hunt, Wesgt Brunswick (AU)

Correspondence Address: STITES & HARBISON PLLC, 1199 NORTH FAIRFAX STREET, SUITE 900, ALEXANDRIA, VA, 22314, US

(21) Appl. No.: 11/206,295

(22) Filed: Aug. 18, 2005

Related U.S. Application Data
(60) Provisional application No. 60/602,892, filed on Aug. 20, 2004.

(51) Int. Cl. H04L 9/00

(52) U.S. Cl. 713/156

(57) ABSTRACT

An apparatus and method for sending email, the apparatus comprising an encryption policy database for storing encryption policies pertaining to possible addressees, and a mail mediator for intercepting an email message after being dispatched by a mail user agent, and configured to retrieve any encryption policy pertaining to the addressee from the encryption policy database and to apply the encryption policy to the email message. The mail mediator attempts to encrypt the email message if the encryption policy pertaining to the addressee dictates that the email message should be encrypted

### RELATED APPLICATION

This application is based on and claims the benefit of the filing date of U.S. application Ser. No. 60/602,892 filed 20 Aug. 2004, the content of which is incorporated herein by reference in its entirety.

### FIELD OF THE INVENTION

The present invention relates to a method and system for encrypting email messages, of particular but by no means exclusive application in the exchange of email messages between multiple organisations. In the description that follows, the terms “an email” and “an email message” are at times used synonymously, as are “emails” and “email messages” and the like.

### BACKGROUND OF THE INVENTION

Many email clients developed since the mid 1990s have included some facility for supporting the encryption and decryption of email, such facilities have remained largely unused owing to user reticence due to the following shortcomings:
There is a plurality of encryption techniques in standard use;
A user must cater for many use scenarios, adding substantially to complexity;
Encryption, authentication and security raise numerous issues that are complex and typically beyond the average user's expertise;
Security and encryption terminology is confusing for most users and for many IT professionals;
The creation, distribution and configuration of encryption keys (e.g. certificates) has been poorly documented and engineered by the IT industry;
Many encryption facilities in email clients have been poorly engineered;
Users are commonly required to perform many technical tasks manually, independently and asynchronously, and to interact separately with many pieces of disconnected applications;
Many existing systems require manual key management, resulting in further complexity and confusion for users.

One or more of these factors have discouraged the use by many users of most encryption techniques, such that the majority of potential users of encryption techniques are unable or unwilling to establish secure email communications.

For example, one existing approach for providing secure email has been to force users to use an ASP (Application Service Provider) model for their email. This substantially removes flexibility, productivity, power, functionality and choice from the user and is considered here to be a non-solution.

Another existing approach involves a central server based solution. This is inappropriate for an individual user and for users within organisations that must send encrypted emails outside their immediate organisation, because such approaches require recipient organisations to deploy the same technique. Such approaches could be said merely to divert the problem of key management from the individual user to an organisation's technical staff, rather than provide a real solution to the complexity of securing email. Another existing approach employs a combination of central server and browser based facilities, but suffers from the same shortcomings.

Some existing techniques employ self-decrypting attachments. In this approach, a recipient is sent an email with an attached executable program. The message content is included within the executable program. When the email is received, the recipient is required to execute this program (typically by double-clicking on it in their Mail User Agent or MUA). The program then decrypts the message content that it contains. However, it is not possible to virus check the attachment before executing it, in contravention of common user and corporate policies concerning the execution of email attachments.

Another problem of some existing approaches is that they are not policy based, so it is possible for users to forget to encrypt emails that should have been encrypted. Also, some existing systems have no mechanism to deal with a failure to locate some necessary component, such as a recipient's certificate. If the user cannot provide the location of that component, the attempt to encrypt or decrypt the email, or indeed to send or open the email, is aborted or the requested action proceeds in an insecure manner.

Some existing approaches also require a high (and often unavailable) level of compatibility between respective MUAs.

### SUMMARY OF THE INVENTION

The present invention, in a first broad aspect, provides an apparatus for sending email, comprising:

an encryption policy database for storing encryption policies pertaining to possible addressees; and

a mail mediator for intercepting an email message after being dispatched by a mail user agent, and configured to retrieve any encryption policy pertaining to the addressee from the encryption policy database and to apply the encryption policy to the email message;

wherein the mail mediator attempts to encrypt the email message if the encryption policy pertaining to the addressee dictates that the email message should be encrypted.

The mail mediator typically comprises software, and could be embodied in a mail proxy or the like having the features of the mail mediator described above.

The apparatus may be a computing apparatus or other electronic device (such as a mobile telephone or a personal digital assistant).

Preferably, the apparatus includes a certificate database for storing digital certificates (or the like) for at least the possible addressees, wherein if the encryption policy pertaining to the addressee dictates that the email message should be encrypted, the mail mediator is configured to attempt to retrieve a digital certificate pertaining to the addressee and to attempt to encrypt the email message using the digital certificate pertaining to the addressee.

In one embodiment, if the mail mediator cannot locate a digital certificate for the addressee, the mail mediator is configured to send an invitation email message to the addressee for inviting and assisting the addressee to obtain and install software so that an addressee apparatus can operate like the apparatus, to obtain a digital certificate and to send the digital certificate once obtained to the apparatus so that the email message can be encrypted and sent to the addressee.

Preferably the mail mediator is interposed between the mail user agent and a mail transfer agent.

The present invention, in a second broad aspect, provides a method of sending email, comprising:

intercepting an email message dispatched to an addressee by a mail user agent;

retrieving any encryption policy pertaining to the addressee from an encryption policy database;

applying the encryption policy to the email message;

attempting to encrypt the email message if the encryption policy pertaining to the addressee dictates that the email message should be encrypted.

Preferably the method includes, if the encryption policy pertaining to the addressee dictates that the email message should be encrypted, attempting to retrieve a digital certificate pertaining to the addressee from a digital certificate database and attempting to encrypt the email message using the digital certificate pertaining to the addressee.

In one embodiment, the method includes, if a digital certificate for the addressee is not located, sending an invitation email message to the addressee for inviting and assisting the addressee to obtain a digital certificate and to send the digital certificate once obtained to the apparatus so that the email message can be encrypted and sent to the addressee.

Preferably the method includes providing a mail mediator interposed between the mail user agent and a mail transfer agent. More preferably the method includes providing a mail mediator interposed between the mail user agent and a mail transfer agent, and another such mail mediator between an addressee mail user agent and an addressee mail transfer agent.

Thus, by means of the invention users can automatically request and exchange certificates so that encrypted emails may be transmitted from sender to recipient (i.e. addressee) and the recipient can receive and read those emails without his or her MUA needing to know how to decrypt the email (since the mail mediator is interposed between the addressee's MUA and MTA).

The present invention, in a third broad aspect, provides an apparatus for sending email, comprising:

a mail mediator for intercepting and encrypting an outgoing email message addressed to the addressee, wherein the mail mediator is configured:

if the apparatus has an addressee digital security mechanism (such as a digital certificate) pertaining to the addressee, to employ the addressee digital security mechanism to encrypt the outgoing email message and subsequently to dispatch the encrypted email message; and

if the apparatus does not have an addressee digital security mechanism pertaining to the addressee, to send an unencrypted request for the addressee digital security mechanism to the addressee and, if the addressee digital security mechanism is subsequently received from the addressee, to employ the addressee digital security mechanism to encrypt the outgoing email message and subsequently to dispatch the encrypted email message.

Preferably the unencrypted request for the addressee digital security mechanism is adapted to be intercepted and acted upon by an addressee mail mediator comparable to the mail mediator so that the mail mediator can receive the addressee digital security mechanism.

More preferably the unencrypted request for the addressee digital security mechanism is adapted to appear to the addressee as an invitation to install (and preferably a mechanism—such as a hypertext link—for initiating the installation of) an addressee mail mediator if not intercepted by an addressee mail mediator.

The present invention, in a fourth broad aspect, provides a method of sending email, comprising:

intercepting an outgoing email message dispatched to an addressee;

if an addressee digital security mechanism pertaining to the addressee is available, employing the addressee digital security mechanism to encrypt the outgoing email message and subsequently dispatching the encrypted email message; and

if an addressee digital security mechanism pertaining to the addressee is unavailable, sending an unencrypted request for the addressee digital security mechanism to the addressee and, if the addressee digital security mechanism is subsequently received from the addressee, employing the addressee digital security mechanism to encrypt the outgoing email message and subsequently dispatching the encrypted email message.

Preferably the unencrypted request for the addressee digital security mechanism is adapted to be intercepted and acted upon by an addressee mail mediator comparable to the mail mediator so that the mail mediator can receive the addressee digital security mechanism.

More preferably the unencrypted request for the addressee digital security mechanism is adapted to appear to the addressee as an invitation to install (and preferably a mechanism—such as a hypertext link—for initiating the installation of) an addressee mail mediator if not intercepted by an addressee mail mediator.

In another aspect, the invention provides a computer readable medium provided with program portions for controlling a device to perform any of the above-described methods.

### BRIEF DESCRIPTION OF THE DRAWING

In order that the invention may be more clearly ascertained, embodiments will now be described, by way of example, with reference to the accompanying drawing, in which:

FIG. 1 is a schematic view of an email system according to an embodiment of the present invention;

FIG. 2 is a schematic view of the computer of the email system of FIG. 1;

FIG. 3 is schematic view of the computer of the email system of FIG. 1 for use by an email sender and of a comparable computer for use by an email recipient according to a first use scenario;

FIG. 4 is schematic view of the computer of the email system of FIG. 1 for use by an email sender and of a comparable computer for use by an email recipient according to a second use scenario;

FIGS. 5A and 5B are schematic views of the computer of the email system of FIG. 1 for use by an email sender and of a computer for use by an email recipient according to a third use scenario; and

FIG. 6 is a schematic view of a data storage medium according to another embodiment.

### DETAILED DESCRIPTON OF THE EMBODIMENT

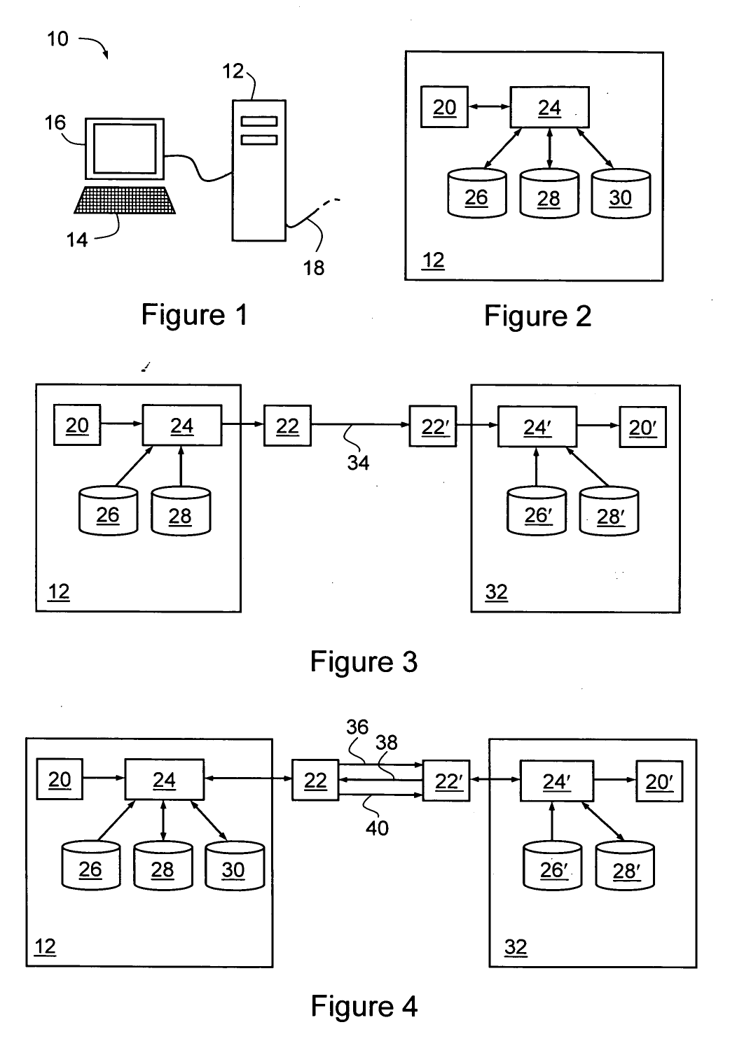

An email system according to an embodiment of the present invention is shown schematically generally at 10 in FIG. 1. The system 10 includes a computer 12, a keyboard 14 and a monitor 16. The system 10 is connected to a computer network over which email can be sent and received by the system 10.

While in this embodiment the platform of system 10 is essentially a personal computer, it will be understood by those in the art that any alternative platform may be employed; in particular, it is envisaged that the system would be especially useful in corporate environments and be installed in or as a server.

Computer 12 includes a processor, a hard disk, communications bus, an operating system, an email client and such other software and hardware components as are commonly provided in, for example, the computer of a personal computer. In particular, and referring to FIG. 2 (which is a schematic view of a selection of the contents of the computer 12), the computer 12 includes, as a component of the email client, a Mail User Agent or MUA 20, a mail mediator 24 (to be discussed further below), a policy database 26, a certificate database 28 and a parked email database 30. In practice, the policy, certificate and parked email databases will commonly be located physically on the hard disk of system 10.

It will be understood by those in the art that the email client will communicate with a Mail Transfer Agent or MTA, but—because the MTA is generally not a component of the computer—it is not shown in this figure.

The mail mediator is used in order to minimise the disruption to the user's email environment, maximise the transparency of the system, allow the user transparently to change MTAs and MUAs without reconfiguration or reinstallation of the mail mediator 24, and to maximise the interoperability with all MTAs and MUAs.

The mail mediator 24 resides logically between the MUA 20 and the user's MTA. The mail mediator 24 performs all of the encryption, decryption, signing, and signature validation for emails, and additionally performs the appropriate automated key management, policy enforcement, initiation generation, and email annotations as required. Wherever feasible, mail mediator 24 uses existing standards in order to maximise security, familiarity and user acceptance. Thus, mail mediator 24 uses MIME and S/MIME, PKI, X.509 certificates, SMTP, POP and IMAP. The mail mediator 24 is compatible with MIME compliant MUAs (such as Outlook and Outlook Express (trade marks of Microsoft Corporation), Netscape Messenger and Mozilla (trade marks of Netscape Communications Corporation), Eudora (a trade mark of Qualcomm Incorporated) and Lotus Notes (a trade mark of Lotus Development Corporation)). The mail mediator 24 is also compatible with all SMTP, POP and IMAP compliant MTAs such as Microsoft Exchange, Lotus Notes, Oracle Collaboration Suite (a trade mark of Oracle International Corporation), and also with popular Unix (a trade mark of Unixsystem Laboratories, Inc.) based applications, such as sendmail and popper.

The mail mediator 24 automates key management as far as is possible, without violating security policies. Mail mediator 24 does not prevent virus checkers from checking the mail mediator code, and allows virus checkers to scan all emails—including their attachments—after decryption (described below) and before the MUA of the recipient (i.e. the addressee) processes the email.

The mail mediator 24 includes code for generating a user interface so that the user can establish “policies”. These are then stored for later inspection or amendment in policy database 26. The user can use this interface to enter or retrieve (from an address book) the email address of a correspondent, and select from a menu of alternative policies to be applied to outgoing email addressed to that email address. Possible policies for a particular addressee are:

always encrypt; or

never encrypt.

It will be appreciated that any number of additional policies can be created if required.

If no policy is located for a particular email address, the user may be prompted (if user preferences so dictate) to select—when an email is sent to that address—which of the policies should be applied to all emails (including the instant email) addressed to that address. The user selects either “always encrypt” or “never encrypt”; the instant email is either encrypted or not encrypted accordingly, and the selected policy is stored against that address in policy database 26.

Policies can also be created for email received from any particular address. If a received email is encrypted, signed by a certificate that is current, and was sent by a sender who is trusted, the email will be accepted. However, these exacting conditions may not always be met, so three additional policies can be established for an address from which emails might be received. These policies collectively dictate how mail mediator 24 should treat emails received from that address. The three scenarios and alternative policies are as follows.

1) The received email is signed by a certificate that has expired:
accept the email;
bounce the email back to the sender (and optionally log the event) (default, including logging); or
discard the email (and optionally log the event).

2) The received email is not signed but the user has a certificate for the sender and that sender is trusted:
accept the email (default);
bounce the email with a reminder (and optionally log the event); or
discard the email (optionally logging).

3) The received email is not encrypted but the user has a certificate for the sender and that sender is trusted:
accept the email (default);
bounce the email with a reminder (and optionally log the event); or
discard the email (and optionally log the event).

It will be noted that a default option exists in each case, and is applied until the user selects an alternative. These defaults pertain to a version of the mail mediator designed to be distributed for free, but it should be appreciated that other versions (such as for corporate environments) may have other default settings.

If, as a result of the application of the policies for a particular intended recipient, an outgoing email is deemed to require encryption, that recipient's certificate—if possessed by the system 10—is stored in the certificate database 28 and retrieved when needed. As is explained in greater detail below, if a certificate is required owing to the relevant policy but is not held in the certificate database 28, the email is held in the parked emails database 30 until the required certificate is obtained (and stored in certificate database 28).

Thus, the mail mediator 24 is policy based and fail-safe, in that a user can feel comfortable that accidents will not occur since an email to a recipient that should be encrypted is encrypted or not sent. The user is not required to remember to encrypt emails to that recipient after the appropriate policy has been entered, and stored in policy database 26.

Further, upon receipt of a signed and/or encrypted email, the mediator 24 transforms the email into a validated and unencrypted email, with appropriate MIME and plain text annotations to indicate the secured status of incoming emails.

In use, mail mediator 24 streamlines the sending and receiving of signed and encrypted email by automating the establishment process of gaining the relevant security information including a recipient's certificate. When a user wishes to send an email to a recipient and the policy applicable to that user requires that such emails be encrypted, mail mediator 24 automates the process of locating that recipient's certificate in certificate database 28 and of obtaining that recipient's certificate when it is not located in the certificate database 28. The only interaction required between mail mediator 24 and the sending user involves the user indicating assent to the accepting of trust on a new certificate for a recipient if the policy obliges the sender to use encryption.

Mail mediator 24 may be configured to operate in either transparent (no configuration changes to the MUA and/or MTA) or non-transparent (configuration changes to MUA and/or MTA) modes. The mail mediator 24 intercepts all relevant email traffic between the MUA and the MTA (e.g. SMTP, POP, IMAP).

These and other features of the system 10 will be more clearly understood by reference to the following exemplary operational scenarios. The following discussion describes a number of scenarios of the use of the email system 10 of FIG. 1, and thereby illustrates various features of the system. In each case the sending user has configured the system policy with respect to outgoing emails addressed to the intended (and, it is hoped, ultimately actual) recipient to be “always encrypt”.

Scenario 1

This scenario is illustrated schematically in FIG. 3, which is comparable to FIG. 2 and hence a schematic view of a selection of the contents of the computer 12. FIG. 3 also depicts a selection of the contents of an essentially identical computer 32 of the intended recipient. In FIG. 3 (and subsequent figures), like reference numerals are used to indicate like features, including those shown in FIG. 2, though like features of the recipient's computer 32 are indicated with primed reference numerals. Furthermore, in each case some features are omitted for the sake of clarity.

Thus, in this first scenario, the user is a sender using the email system 10 who attempts to send an email to a recipient, where the sender has the recipient's certificate in his or her certificate database 28 and the recipient also has the system 10 installed.

The sender sends an email message from his or her MUA 20. The user's mail mediator 24 intercepts the outgoing email, fetches the policy for the recipient from the policy database 26, determines from the policy that the email requires encryption, fetches the sender's certificate and the recipient's certificate from certificate database 28, signs and encrypts the email, passes it to the user's MTA 22, which sends it 34 to the recipient.

The recipient's MTA 22′ receives the email and forwards it to the recipient's MUA 20′. However, the recipient's mail mediator 24′ intercepts the signed and encrypted email from the sender, fetches the sender's certificate and recipient's certificate from the recipient's certificate database 28′, decrypts the email, validates the signature, fetches from the recipient's policy database 26′ the policy for receiving emails from the sender, verifies that the email meets the policy requirements, annotates the email to indicate that it had been received validly signed and encrypted (or otherwise), and forwards to the recipient's MUA 20′.

Scenario 2

In this scenario—described by reference to FIG. 4—the sender has system 10, but does not have the recipient's certificate. Consequently, the sender does not know if the recipient has system 10 (though it transpires that the recipient does).

The sender sends an email message from his or her MUA 20. The sender's mail mediator 24 intercepts the outgoing email, fetches the policy for the recipient from the policy database 26, determines from the policy that the email should be encrypted, but finds no certificate for the recipient in the certificate database 28. Thus, it parks the email message in the parked email database 30, fetches the sender's certificate from the certificate database 28, and sends 36 to the recipient a specially constructed “invitation request” (the nature of which will be apparent from the following description).

The recipient's mail mediator 24′ intercepts the incoming email containing the invitation request, recognises the email, validates the signing chain of the sender, stores the sender's certificate in its certificate database 28′ (if it is not there already), fetches the recipient's certificate from the certificate database 28′, constructs a new “invitation response” email, signs it, attaches the recipient's certificate, and sends 38 this email to the original sender.

The sender's mail mediator 24 intercepts the incoming invitation response email, and validates and stores the recipient's certificate in certificate database 28. The sender's mail mediator 24 then fetches the sender's certificate from its certificate database 28, fetches the parked original email (from parked email database 30) that required encryption, signs (using the sender's certificate) and encrypts (using the receiver's certificate) that email and sends it 40 to the recipient. The ultimate sending 40 of the email is, as will be appreciated, essentially identical with the sending 34 of the email in Scenario 1 illustrated in FIG. 3.

The recipient's mail mediator 24′ intercepts the signed and encrypted email from the sender, fetches both the sender's and recipient's certificates from certificate database 28′, decrypts the email, validates the signature, and fetches the policy for the sender from policy database 26′. If the policy for the sender indicates that the recipient should accept the email, the recipient's mail mediator 24′ annotates the email to indicate that it was validly signed and encrypted (or otherwise), and forwards it to the recipient's MUA 20′ (and hence the email is not forwarded to the recipient's MUA 20′ if the policy does not indicate that the recipient should accept the email). This means that the email is transmitted to the computer 32 of the intended recipient, but is only made available to the recipient's MUA 20′ if the policy pertaining to the sender indicates that the email should be accepted.

Scenario 3

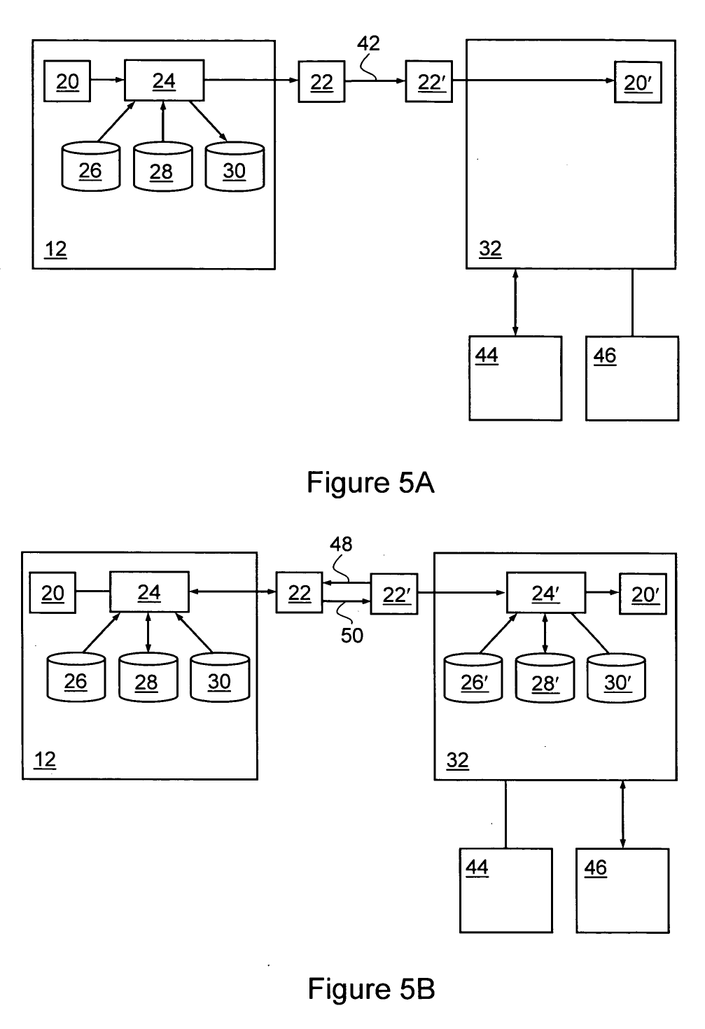

In this scenario (described by reference to FIGS. 5A and 5B), the sender does not have the recipient's certificate so does not know if the recipient has system 10; indeed it transpires that the recipient does not have system 10.

Referring to FIG. 5A, the sender sends an email message from his or her MUA 20. The sender's mail mediator 24 intercepts the outgoing email, fetches the policy for the recipient from policy database 26, and determines from the policy that the email should be encrypted. Mail mediator 24, however, discovers from certificate database 28 that it does not have a certificate for the recipient, so it parks the sender's email message in parked email database 30, fetches the sender's certificate from certificate database 28, and sends 42 to the recipient an “invitation request” email. This sending 42 of an “invitation request” is essentially identical with the sending 36 of an invitation request in Scenario 2 illustrated in FIG. 4.

The recipient receives the invitation request in the inbox of his or her MUA 20′ as a normal email message (since the sender does not have a mail mediator). This invitation request email contains a hypertext link to a download website 44 for downloading, installing and registering a copy of the mail mediator and for obtaining the associated configuration data for establishing the various databases. The invitation request email explains that the user (who is identified) wishes to send an encrypted email and that the recipient should click on the hypertext link to obtain the necessary software.

The recipient could decline to download the mail mediator, in which case the original email will not be sent. If the recipient downloads the mail mediator and installs it, the recipient's computer 32 then assumes the configuration shown in FIG. 5B. The recipient now possesses a system comparable with system 10.

The newly installed mail mediator 24′ informs the recipient that registration is required in order to receive an Email X.509 Certificate for the recipient. The recipient enters the information required for a Certificate and clicks a “Register” button.

Mail mediator 24′ generates a PKI key pair, stores the Private Key in its Keystore Database (not shown), generates a “Certificate Request” and directs the recipient to a Registration Website 46 with the Certificate Request. The Registration Website 46 guides the recipient through the registration process and completes registration of the recipient's copy of the mail mediator 24′.

The Registration Website 46 sends to the recipient the newly created recipient certificate as an email. The mail mediator 24′ intercepts incoming email from containing recipient's certificate, validates the signing chain and stores the recipient's certificate in its certificate database 28′.

The recipient's mail mediator 24′ prompts the recipient to return to the invitation request email in the inbox of his or her MUA 20′ and to confirm (by clicking on ‘reply’ and ‘send’ and hence replying to the invitation request) that the recipient wishes to proceed. If the recipient does so, the mail mediator 24′ accepts the invitation request, fetches the recipient's certificate from certificate database 28′, stores the sender's certificate from the invitation request in the certificate database 28′, constructs a new invitation response email, signs it, attaches the recipient's certificate, and sends 48 (comparable to sending 38 in Scenario 2) this invitation response email to the original sender.

The sender's mail mediator 24 intercepts the incoming invitation response email, and validates and stores the recipient's certificate in its certificate database 28. The sender's mail mediator 24 fetches the sender's certificate from its certificate database 28′, fetches the parked original email from its parked email database 30, signs and encrypts that email and sends it 50 to the recipient. The ultimate sending 50 of the email is essentially identical with the sending 34 of the email in Scenario 1 illustrated in FIG. 3.

The recipient's mail mediator 24′ intercepts the signed and encrypted email from the sender, fetches both the sender's and recipient's certificates from certificate database 28′, decrypts the email, validates the signature, fetches the policy for the sender from policy database 26′, and—if the policy says to accept the email—annotates the email to indicate that it was validly signed and encrypted (or otherwise) and forwards it to the recipient's MUA 20′.

Optionally, the recipient's mail mediator 24′ may, after being instructed by the recipient to accept the sender's invitation request, prompt the recipient to set the policies for the sender to apply to, respectively, emails to be sent to the sender and to emails received from the sender. Alternatively, this can be done at some later time by the recipient.

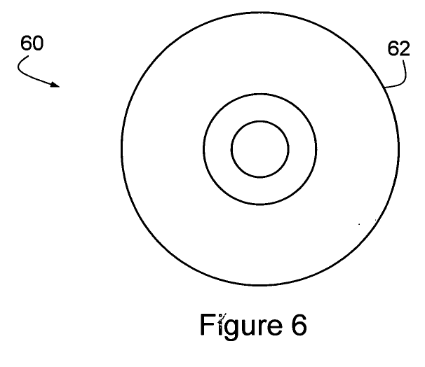

FIG. 6 is a schematic view of a data storage medium 60 according to another embodiment. The data storage medium 60 is in the form of a CD-ROM 62 that contains program instructions for effecting the techniques described by reference to FIGS. 1 to 5B and hence for creating an email system comparable to system 10. It will be understood that, in this embodiment, the particular type of data storage medium may be selected according to need or other requirements. For example, instead of CD-ROM 62 the data storage medium 60 could be in the form of a magnetic medium, but essentially any data storage medium will suffice. Indeed, the user need not be aware of which type of data storage medium is used, as the actual data storage medium could be located and accessed remotely.

Important benefits of these embodiments, therefore, include:
the provision of secured encrypted and digitally signed email;
Great ease of use, so no complex set-up is required;
No need for hosted services;
Each user can use his or her own existing email client;
Each user can use his or her own existing ISP or corporate mail server;
Users are not required to remember to encrypt;
A flexible configuration;
Personal and corporate policy enforcement is possible;
Readily implemented for all common platforms;
Simple, flexible opt-in methodology;
Interoperability with users who use MUA-based encryption and signing, and interoperability with users who do not use any form of encryption and signing;
Fully X.509 certificate and S/MIME compliant;
The ability to automatically switch between personal and corporate versions and mail servers if desired;
Users can transparently change MUAs and MTAs;
Encrypted email initiation methodology and technology, which provides the ability to keep encrypted emails flowing between individuals and organisations in a seamless manner, while addressing the key management issue by automating key management without requiring the user to have extensive technical skills, special servers, or to use hosted services.

Thus, modifications within the scope of the invention may be readily effected by those skilled in the art. It is to be understood, therefore, that this invention is not limited to the particular embodiments described by way of example hereinabove.

In the preceding description of the invention, except where the context requires otherwise owing to express language or necessary implication, the word “comprise” or variations such as “comprises” or “comprising” is used in an inclusive sense, i.e. to specify the presence of the stated features but not to preclude the presence or addition of further features in various embodiments of the invention.

Further, any reference herein to prior art is not intended to imply that such prior art forms or formed a part of the common general knowledge.

1. An apparatus for sending email, comprising:
an encryption policy database for storing encryption policies pertaining to possible addressees; and
a mail mediator for intercepting an email message after being dispatched by a mail user agent, and configured to retrieve any encryption policy pertaining to said addressee from said encryption policy database and to apply said encryption policy to said email message;
wherein said mail mediator attempts to encrypt said email message if said encryption policy pertaining to said addressee dictates that said email message should be encrypted.

2. An apparatus as claimed in claim 1, including a certificate database for storing digital certificates for at least said possible addressees, wherein if said encryption policy pertaining to said addressee dictates that said email message should be encrypted, said mail mediator is configured to attempt to retrieve a digital certificate pertaining to said addressee and to attempt to encrypt said email message using said digital certificate pertaining to said addressee.

3. An apparatus as claimed in claim 2, wherein said mail mediator is configured so that, if said mail mediator cannot locate a digital certificate for said addressee, said mail mediator sends an invitation email message to said addressee for inviting and assisting said addressee to obtain and install software so that an addressee apparatus can operate like said apparatus, to obtain a digital certificate and to send said digital certificate once obtained to said apparatus so that said email message can be encrypted and sent to said addressee.

4. An apparatus as claimed in claim 1, wherein said mail mediator is interposed between the mail user agent and a mail transfer agent.

5. A method of sending email, comprising:
intercepting an email message dispatched to an addressee by a mail user agent;
retrieving any encryption policy pertaining to said addressee from an encryption policy database;
applying said encryption policy to said email message;
attempting to encrypt said email message if said encryption policy pertaining to said addressee dictates that said email message should be encrypted.

6. A method as claimed in claim 5, including, if said encryption policy pertaining to said addressee dictates that said email message should be encrypted, attempting to retrieve a digital certificate pertaining to said addressee from a digital certificate database and attempting to encrypt said email message using said digital certificate pertaining to said addressee.

7. A method as claimed in claim 5, including, if a digital certificate for said addressee is not located, sending an invitation email message to said addressee for inviting and assisting said addressee to obtain a digital certificate and to send said digital certificate once obtained to said apparatus so that said email message can be encrypted and sent to said addressee.

8. A method as claimed in claim 5, including providing a mail mediator interposed between said mail user agent and a mail transfer agent.

9. A method as claimed in claim 8, including providing another such mail mediator between an addressee mail user agent and an addressee mail transfer agent.

10. An apparatus for sending email, comprising:
a mail mediator for intercepting and encrypting an outgoing email message addressed to said addressee, wherein said mail mediator is configured:
if said apparatus has an addressee digital security mechanism (such as a digital certificate) pertaining to said addressee, to employ said addressee digital security mechanism to encrypt said outgoing email message and subsequently to dispatch said encrypted email message; and
if said apparatus does not have an addressee digital security mechanism pertaining to said addressee, to send an unencrypted request for said addressee digital security mechanism to said addressee and, if said addressee digital security mechanism is subsequently received from said addressee, to employ said addressee digital security mechanism to encrypt said outgoing email message and subsequently to dispatch said encrypted email message.

11. An apparatus as claimed in claim 10, wherein said unencrypted request for said addressee digital security mechanism is adapted to be intercepted and acted upon by an addressee mail mediator comparable to said mail mediator so that said mail mediator can receive said addressee digital security mechanism.

12. An apparatus as claimed in claim 11, wherein said unencrypted request for said addressee digital security mechanism is adapted to appear to said addressee as an invitation to install an addressee mail mediator if not intercepted by an addressee mail mediator.

13. An apparatus as claimed in claim 12, wherein said unencrypted request includes a mechanism to initiate the installation of said addressee mail mediator.

14. An apparatus as claimed in claim 12, wherein said unencrypted request includes a hypertext link for initiating the installation of said addressee mail mediator.

15. A method of sending email, comprising:
intercepting an outgoing email message dispatched to an addressee;
if an addressee digital security mechanism pertaining to said addressee is available, employing said addressee digital security mechanism to encrypt said outgoing email message and subsequently dispatching said encrypted email message; and
if an addressee digital security mechanism pertaining to said addressee is unavailable, sending an unencrypted request for said addressee digital security mechanism to said addressee and, if said addressee digital security mechanism is subsequently received from said addressee, employing said addressee digital security mechanism to encrypt said outgoing email message and subsequently dispatching said encrypted email message.

16. A method as claimed in claim 15, wherein said unencrypted request for said addressee digital security mechanism is adapted to be intercepted and acted upon by an addressee mail mediator comparable to said mail mediator so that said mail mediator can receive said addressee digital security mechanism.

17. A method as claimed in claim 15, including adapting said unencrypted request for said addressee digital security mechanism to appear to said addressee as an invitation to install an addressee mail mediator if not intercepted by an addressee mail mediator.

18. A method as claimed in claim 17, including providing a mechanism in said unencrypted request for initiating the installation of said addressee mail mediator.

19. A method as claimed in claim 17, including providing a hypertext link in said unencrypted request for initiating the installation of said addressee mail mediator.

20. A computer readable medium provided with program portions for controlling a device to perform the steps of the method of claim 5.

21. A computer program product directly loadable into the internal memory of a computer, comprising software code portions for performing the steps of the method of claim 5 when said product is run on a computer.

22. A computer program product stored an a computer readable medium for causing a computer to perform the steps of the method of claim 5.

22. A computer readable medium provided with program portions for controlling a device to perform the steps of the method of claim 15.

23. A computer program product directly loadable into the internal memory of a computer, comprising software code portions for performing the steps of the method of claim 15 when said product is run on a computer.

24. A computer program product stored an a computer readable medium for causing a computer to perform the steps of the method of claim 15.
